(19) United States
(12) Patent Application Publication
(10) Pub. No.: US 2006/0113239 A1
(43) Pub. Date: Jun. 1, 2006

(54) Device and method of classifying emulsion and method of demulsifying emulsion

(76) Inventors: Yoshihito Okubo, Osaka (JP); Taisuke Maki, Kyoto (JP); Masaaki Toma, Nara (JP); Kazuhiro Mae, Kyoto (JP)

Correspondence Address: BIRCH STEWART KOLASCH & BIRCH, PO BOX 747, FALLS CHURCH, VA, 22040-0747, US

(21) Appl. No.: 10/543,662

(22) PCT Filed: Jan. 26, 2004
(86) PCT No.: PCT/JP04/00672

§ 371 Date: Jul. 28, 2005

(30) Foreign Application Priority Data
Jan. 31, 2003 (JP) 2003-023913
Aug. 28, 2003 (JP) 2003-209390

(51) Int. Cl. B01D 29/00; B01D 24/00

(52) U.S. Cl. 210/348

(57) ABSTRACT

A classifying apparatus (1) has a flow path (structure) through which an emulsion flows. The flow path is provided between at least two plates (upper plate (2), lower plate (4)) that are separated by a distance smaller than the largest diameter of a liquid droplet included in the emulsion. Emulsion is fed from a supply port (5) provided in the upper plate (2) and can be classified by passing it in the flow path.

### TECHNICAL FIELD

The present invention relates to a classifying apparatus and a classifying method of obtaining only tiny liquid droplets by an emulsion classification performed in such a manner that large liquid particles (liquid droplets) in an emulsion containing liquid droplets with different particle diameters (droplet diameters) are made coalesced with each other. More specifically, the present invention relates to a classifying apparatus and a classifying method capable of demulsifying liquid droplets to a continuous phase by classifying the emulsion to obtain liquid droplets having so small diameter that cannot be visually observed.

### BACKGROUND ART

A liquid-liquid extraction performed in such a manner that after a useful substance dissolved in an aqueous phase is extracted to an oil phase, or after a salt and other substance dissolved in an oil phase is extracted to an aqueous phase, the useful substance and the salt are extracted by separation into the aqueous phase and the oil phase, is an operation widely adopted in the industries such as environmental industry involving a waste water treatment, pharmaceutical and agricultural chemical industries, chemical industry, and food industry. The liquid-liquid extraction is, for example, an operation of transferring a useful substance and salt dissolved in an aqueous phase or an oil phase into other liquid phase.

For enhancement of efficiency in the liquid-liquid extraction, generally performed is a phase-separation after another liquid droplets are made dispersed in one liquid phase by agitation or the like for production of an emulsion. That is, increase in an area of an interface (interface area) between mutually different phases enhances efficiency in liquid-liquid extraction. Specifically, it is generally known that liquid droplets having a smaller diameter contained in the emulsion increase an interface area between the different two phases, which brings a prompt extraction of a useful substance and salt (For example, non-patent document 1).

By the way, there has been a demand for a more prompt liquid-liquid extraction, which is required to address the problems such as decomposition of a useful substance by reaction with one phase and decomposition of a useful substance in temperatures necessary for the extraction. Recently, non-patent document 2 has suggested a method of promptly extracting a useful substance (phenol) from an aqueous phase to an oil phase (dodecane phase) with the use of an emulsion having submicron-diameter liquid droplets, generated by using an apparatus termed as “micromixer”.

However, for example, in the emulsion generated by the method disclosed in the non-patent document 2 and an emulsion containing an emulsifier, liquid droplets contained in these emulsions exist stable without coalescing with one another. Therefore, these emulsions may keep stable for a long time. Thus, when such a stable emulsion is used, i.e. when demulsification is not readily performed, it takes long time to separate the emulsion into two liquids even though the extraction is performed promptly.

For example, patent documents 1 and 2 disclose a method for solving such a problem.

Specifically, in the method disclosed in patent documents 1 and 2, an emulsion is separated into oil and water in such a manner that the emulsion is made passed through a filter realized by a textile having a very small hole diameter. In the method disclosed in the patent documents 1 and 2, the filter collects liquid droplets contained in the emulsion as the emulsion passes through the filter. Then, when these liquid droplets join together to form a large droplet, the large droplet is discharged out of the filter.

[Non-patent document 1]

“Theory and Calculation of the Chemical Machine”, 2nd ed., p. 288, Saburoh Kamei, Sangyotosho Corp. (1975)

[Non-patent document 2]

Preprint G216 of 35th Autumn Annual Meeting by the Society of Chemical Engineers, Japan, Maki, Mae et al. (2002)

[Patent document 1]

Japanese Patent No. 2572068 (registered on Oct. 24, 1996)

[Patent document 2]

Japanese Laid-Open Patent Application No. 2000/288303 (Published on Oct. 17, 2000)

By the way, in the arrangements disclosed in the patent documents 1 and 2, separation of an emulsion into oil and water is performed using the filters. These filters, which are realized by textiles, have grains of random opening diameters. Therefore, when a liquid droplet smaller than the opening diameters flows through the filter in a spot having relatively large opening diameter, for example, the liquid droplet passes straight through the relatively large opening of the filter without coalescing with other liquid droplet. In other words, liquid droplets contained in the emulsion cannot coalesce with each other depending upon spots of the flow path through which an emulsion passes.

Thus, the arrangement of the patent document 1 cannot adjust opening diameters of the flow path through which liquid droplets contained in the emulsion pass in the filter to make uniform opening diameters, thus making impossible to classify liquid droplets passing though the filter so as to obtain droplets having a desired diameter or smaller.

Further, the arrangements disclosed in the patent documents 1 and 2 cannot adjust the flow path of liquid droplets contained in the emulsion. This needs to precisely adjust a flow rate of the emulsion to be passed through the flow path, for realization of an efficient separation into oil and water. In other words, in the arrangements disclosed in the patent documents 1 and 2, liquid droplets contained in the emulsion do not coalesce with each other, when a flow rate of the emulsion is fast or slow, and do not form one continuous phase. This causes the emulsion to be discharged without demulsified.

Still further, the arrangements disclosed in the patent documents 1 and 2 cannot provide uniform opening diameters of the filter grains. In addition, it becomes more difficult to make a uniform distribution of the opening diameters as the opening diameter of the filter grains becomes smaller. For example, it is very difficult to classify an emulsion having extremely-small-diameter liquid droplets generated with the use of the micromixer disclosed in the non-patent document 2.

Besides, in a case where the filters disclosed in the patent documents 1 and 2 are used, the filters gradually swell due to a long-time separation into oil and water. This increases a liquid passage resistance of the filters. Thus, it is very difficult for the filters to provide a constant oil-and-water separation performance all the time.

### DISCLOSURE OF INVENTION

The present invention has been attained in view of the above problems, and an object thereof is to provide a classifying apparatus and a classifying method for more easily classifying liquid droplets contained in an emulsion to obtain liquid droplets having a desired diameter or smaller.

A classifying apparatus according to the present invention, in order to solve the above problems, has a flow path having a desired depth or width smaller than the largest diameter in liquid droplets contained in an emulsion, wherein at least a part of the flow path is made of a material having affinity with the liquid droplets.

When the emulsion passes through the flow path, the liquid droplets larger than a desired depth or width (hereinafter referred to as the smallest length) smaller than the largest diameter in liquid droplets contained in the emulsion in the flow path, among the liquid droplets contained in the emulsion, deform so as to fit in the smallest length, and the liquid droplets are wetted on a material having an affinity with the liquid droplets (hereinafter it may be referred to as droplet affinity material). Then, when the emulsion is continuously supplied to the flow path, there occurs a difference in relative velocity between a dispersion medium flowing through the flow path and the liquid droplets. This is because the liquid droplets are wetted on the droplet affinity material, and the dispersion medium resists being wetted on the droplet affinity material. Then, if liquid droplets on the upstream of the flow path are smaller in size than liquid droplets on the downstream of the flow path, the liquid droplets on the upstream catch up with the liquid droplets on the downstream. At this moment, the liquid droplets are wetted on the droplet affinity material, and therefore coalesce with other liquid droplets by acting to decrease their surface areas for their stabilities. This causes coalescence of the liquid droplets larger than the smallest length of the flow path to coalesce by passing through the flow path. On the other hand, liquid droplets smaller than the smallest length of the flow path pass without being wetted on the droplet affinity material, and therefore do not coalesce with other liquid droplets. Thus, the smaller liquid droplets keep their shape even after having passed through the flow path.

According to the above arrangement, the liquid droplets larger than the smallest length can be formed to a larger liquid droplet (made coalesced with each other) in such a manner that the liquid droplets contained in the emulsion are caused to pass through the flow path having the smallest length, more specifically, the liquid droplets contained in the emulsion are caused to pass in a wetted state through the flow path. With this, the liquid droplets can coalesce with each other to form a continuous phase, and then separate from the emulsion. Further, the liquid droplets smaller than the smallest length keep as they are.

That is, with the above arrangement, it is possible to reliably flow the liquid droplets contained in the emulsion through the flow path having the smallest length. Thus, it is possible to classify the liquid droplets contained in the emulsion so as to obtain liquid droplets having a desired diameter or smaller.

In order to solve the above problems, a method for classifying emulsion of the present invention includes passing emulsion through a flow path in an apparatus for classifying emulsion, wherein the apparatus has a flow path having a desired depth or width smaller than the largest diameter in liquid droplets contained in the emulsion, and wherein at least a part of walls forming the flow path is made of a material having affinity with the liquid droplets.

According to the above arrangement, the liquid droplets larger than the smallest length can be formed to a larger liquid droplet (made coalesced with each other) in such a manner that the liquid droplets contained in the emulsion are caused to pass through the flow path having the smallest length, more specifically, the liquid droplets contained in the emulsion are caused to pass in a wetted state through the flow path. Further, liquid droplets smaller than the smallest length keep as they are.

That is, with the above arrangement, it is possible to reliably flow the liquid droplets contained in the emulsion through the flow path having the smallest length. Therefore, the liquid droplets larger than the smallest length can coalesce with each other to form a continuous phase, and then separate from the emulsion. Thus, it is possible to classify the liquid droplets contained in the emulsion so as to obtain liquid droplets having a desired diameter or smaller.

A method for demulsifying emulsion of the present invention includes passing emulsion through a flow path in an apparatus for classifying emulsion and phase-separating the passed liquid, wherein the apparatus has a flow path having a desired depth or width smaller than the largest diameter in liquid droplets contained in the emulsion, and wherein at least a part of walls forming the flow path is made of a material having affinity with the liquid droplets.

According to the above arrangement, the liquid droplets larger than the smallest length can be formed to a larger liquid droplet (made coalesced with each other) in such a manner that the liquid droplets contained in the emulsion are caused to pass through the flow path having the smallest length, more specifically, the liquid droplets contained in the emulsion are caused to pass in a wetted state through the flow path. Thus, it is possible to easily phase-separate the emulsion for demulsification.

The following description will sufficiently clarify further objects, characteristics, and excellent points of the present invention. Further, advantages of the invention will be clarified with reference to the ensuing detailed description taken in conjunction with the accompanying drawings.

### BRIEF DESCRIPTION OF DRAWINGS

FIG. 1 is a perspective view illustrating a schematic structure of a classifying apparatus according to the present embodiment.

FIG. 2 is a perspective view illustrating a structure of an upper plate in the classifying apparatus of FIG. 1.

FIG. 3 is a perspective view illustrating a structure of an intermediate plate having a hollow serving as a flow path through which an emulsion flows, and providing a plate-to-plate distance (smallest length) between the upper plate and a lower plate, in the classifying apparatus of FIG. 1.

FIG. 4 is a perspective view illustrating a structure of the lower plate in the classifying apparatus of FIG. 1.

FIG. 5(a) is a front view illustrating how to measure a dynamic advance angle, and FIG. 5(b) is a front view illustrating-how to measure a dynamic retreat angle.

FIGS. 6(a) through 6(c) are cross-sectional views illustrating a classification mechanism of an oil-in-water type emulsion which passes through the flow path.

FIG. 7 is a cross-sectional view illustrating a passage mechanism of an oil-in-water type emulsion which passes through the flow path.

FIG. 8 is a cross-sectional view illustrating a behavior of an oil-in-water type emulsion when it flows through a flow path made of glass only.

FIG. 9 is a front view illustrating an exemplary apparatus connected to the classifying apparatus.

FIG. 10 is a front view illustrating another exemplary apparatus connected to the classifying apparatus.

FIG. 11 is a graph showing droplet diameter distributions of (a) liquid droplets contained in an emulsion before being classified and (b) liquid droplets contained in an emulsion after being classified in Example 5.

FIG. 12 is a diagram illustrating a microscope image showing a state of an emulsion before being classified in Example 5.

FIG. 13 is a diagram illustrating a microscope image showing a state of an emulsion after being classified in Example 5.

FIG. 14 is a graph showing droplet diameter distributions of (a) liquid droplets contained in an emulsion before being classified and (b) liquid droplets contained in an emulsion after being classified in Comparative Examples 2 and 3.

FIG. 15 is a graph showing droplet diameter distributions of (a) liquid droplets contained in an emulsion before being classified and (b) liquid droplets contained in an emulsion after being classified in Examples 10 and 11.

### BEST MODE FOR CARRYING OUT THE INVENTION

The following will describe one embodiment of the present invention. A classifying apparatus according to the present embodiment has a flow path having a desired depth or width smaller than the largest diameter in liquid droplets contained in the emulsion, the flow path having the desired depth or width allowing the emulsion to pass therethrough, wherein at least a part of walls forming the flow path is made of a material having affinity with the liquid droplets contained in the emulsion.

More specifically, examples of the classifying apparatus according to the present embodiment include an apparatus having a structure (flow path) through which an emulsion flows, wherein the flow path is provided between at least two plates that are separated by a distance less than the largest diameter in liquid droplets contained in the emulsion.

The above arrangement allows an emulsion to pass through the flow path. This causes coalescence of liquid droplets larger than the smallest depth or width of the flow path, thus causing a separation into (a) large liquid droplets grown in size by the coalescence and (b) tiny liquid droplets staying without coalescence. The large liquid droplets sufficiently coalesce with one another to form one continuous phase. Then, for demulsification of the emulsion, the emulsion is usually separated into two phases and discharged. The two phases are (i) a continuous phase derived from liquid droplets and (ii) a continuous phase derived from a dispersion medium of the emulsion. In addition, the above arrangement enables a prompt classification (demulsification) of an emulsion having micro-diameter liquid droplets dispersed therein, generated by an apparatus such as the “micromixer”, and an emulsion containing an emulsifier (surfactant). This will be described below.

First, the following will describe an emulsion to be classified by the classifying apparatus according to the present embodiment.

An emulsion according to the present embodiment has (a) a liquid (dispersion medium) and (b) other type of liquid, wherein particles of the liquid (b) in the form of colloidal particles or particles larger than colloidal particles are dispersed in the liquid (a). In the following description, the particles of the liquid refer to liquid droplets.

A liquid droplet contained in the emulsion to be classified (demulsified) by the classifying apparatus according to the present embodiment has more preferably a diameter in a range from 1 μm to 100 μm, further preferably a diameter in a range from 10μm to 50 μm.

Usually, the emulsion is a dispersed system of water and an organic phase, i.e. a system in which liquid droplets are dispersed in other liquid that do not dissolve them. Specifically, examples of the emulsion include: an oil-in-water (O/W) type emulsion in which an organic phase (liquid droplets) is dispersed in water (dispersion medium); and an water-in-oil (W/O) type emulsion in which water (liquid droplets) are dispersed in an organic phase (dispersion medium).

Examples of organic solvents making up the organic phase include: aromatic hydrocarbons such as benzene, toluene, and xylene; aliphatic hydrocarbons such as heptane, hexane, heptane, octane, nonane, decane, dodecane, and tridecane; alicyclic hydrocarbons such as cyclopentane and cyclohexane; halogenated hydrocarbons such as methylene chloride, chloroform, and chlorobenzene; ethers such as dimethyl ether, diethyl ether, ethylene glycol dimethyl ether, propylene glycol dibutyl ether, and tetrahydrofuran; alcohols having approximately 6 to 20 carbon atoms (alcohols may be composed of any types of hydrocarbon radicals such as straight-chain, branched-chain, and cyclic hydrocarbon radicals) such as hexanol, heptanol, octanol, decanol, and dodecanol; methyl isobutyl ketone; and butyl acetate.

Among the exemplary organic solvents, aromatic hydrocarbons, aliphatic hydrocarbons, alicyclic hydrocarbons, and alcohols are used favorably because they have a high distribution coefficient (oil phase/aqueous phase) with respect to a solute (organic compounds), and allows a solute to be distributed in the oil phase in a high proportion. Therefore, when aromatic hydrocarbons, aliphatic hydrocarbons, alicyclic hydrocarbons, and alcohols are used for organic solvents, a classifying apparatus according to the present embodiment can easily demulsify an emulsion generated by extraction of a solute from an aqueous phase, and promptly extract a solute into an oil phase.

Further, the foregoing emulsion may contain an emulsifier, such as surfactant and protective colloid, for stabilization of the emulsion.

Examples of surfactants include: anionic surfactants such as alkylsulfate sulfonate, alkylbenzenesulfonate, alkylsulfosuccinate, alkyl diphenyl ether disulfonate, polyoxyethylene alkali sulfate, and polyoxyethylene alkyl phosphate; nonionic surfactants such as polyoxyethylene-polyoxypropylene block copolymer, polyoxyethylene alkyl ether, polyoxyethylene alkyl phenol ether, polyoxyethylene fatty acid ester, sorbitan fatty acid ester, polyoxyethylene sorbitan fatty acid ester, polyoxyethylene alkylamine, and glycerine fatty acid ester; cationic surfactants such as alkylamine salts and quaternary ammonium salts including tetraalkyl ammonium halide and benzil trialkyl ammonium halide.

Examples of protective colloids include: polyvinyl alcohols such as partially saponified polyvinyl alcohol, completely saponified polyvinyl alcohol, sulfonate-modified polyvinyl alcohol, carboxyl-modified polyvinyl alcohol, silanol-modified polyvinyl alcohol; and cellulose derivatives such as hydroxyethyl cellulose, methyl cellulose, and carboxymethyl cellulose.

Further, the emulsifier may be a combination of different types of emulsifiers, such as surfactant and protective colloid.

For example, an emulsion is generated by washing an organic phase obtained by an organic synthesis reaction, when a surfactant (specifically, e.g. tetraalkylammonium salt and benzyltrialkylammonium salt) is used as a phase-transfer catalyst, or when a substrate and a reaction product in the organic synthesis reaction are ammonium salt and carboxylate salt. Liquid droplets contained in this emulsion have a diameter of about 10 μm to 50 μm. Therefore, it is possible to realize a more favorable classification (demulsification) of the emulsion with the use of the classifying apparatus according to the present embodiment.

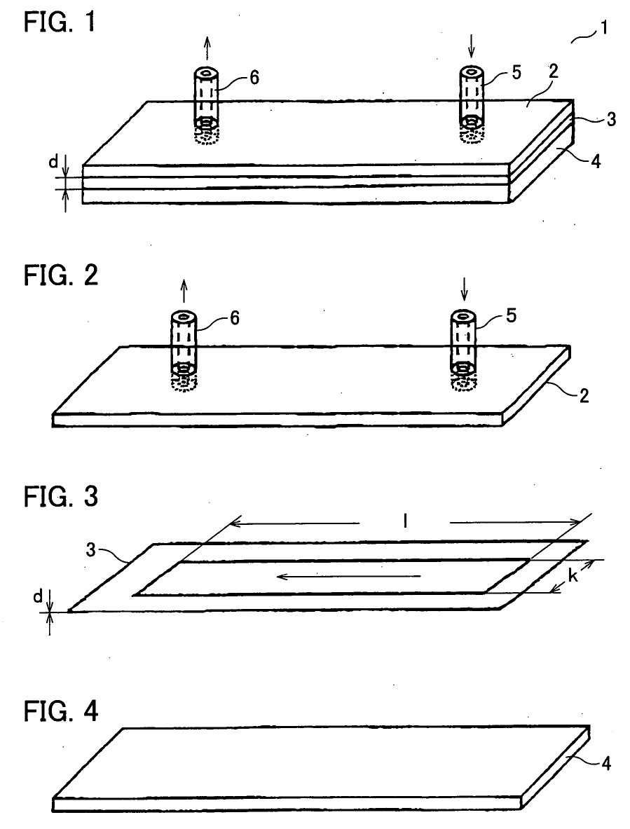

FIG. 1 is a perspective view illustrating a schematic structure of a classifying apparatus 1 according to the present embodiment. As illustrated in FIG. 1, the classifying apparatus 1 has a structure in which an intermediate plate 3 (see FIG. 3) having a hollow that serves as a flow path through which an emulsion flows, is sandwiched between an upper plate (plate member) 2 (see FIG. 2) and a lower plate (plate member) 4 (see FIG. 4). That is, as illustrated in FIG. 3, the hollow formed between the upper plate 2 and the lower plate 4, both of which are separated by the intermediate plate 3, is the flow path through which the emulsion passes. As illustrated in FIGS. 1 and 2, the upper plate 2 is provided with a supply port 5 that supplies an emulsion and an exit 6 that discharges a classified (demulsified) liquid.

The smallest length (plate-to-plate distance) between the upper plate 2 and the lower plate 4 in the classifying apparatus 1 according to the present embodiment, i.e. thickness of the intermediate plate 3 is set to be equal to or less than the largest diameter in liquid droplets contained in the emulsion to be passed, and to be equal to or less than a desired classification length, i.e. a desired diameter of liquid droplets contained in the emulsion to be classified. Preferably, it is set to be equal to or less than a volume average diameter of the liquid droplets. For example, in a case where an oil-in-water type emulsion in which liquid droplets that are oil droplets whose maximum diameter is 10 μm are dispersed in an aqueous phase, is separated into, as a continuous phase, an oil phase realized by coalescence of liquid droplets having more than 10 μm in diameter, the smallest length, i.e. thickness of the intermediate plate 3 is set to be equal to or less than 10 μm.

Specifically, the smallest length, which differs depending upon the type of emulsion to be classified (demulsified), is preferably in a range from 1 to 100 μm. With the smallest length in this range, a residence time required for liquid-separation tends to be shortened. Especially, in a case when an emulsion having tiny liquid droplets that allow a quick extraction thereof, like an emulsion generated by a micromixer, is used, the smallest length is preferably in a range from 1 to 50 μm. Note that, the “flow path” herein refers to a region having a depth or width smaller than the largest diameter in liquid droplets contained in the emulsion to be flown, in an area of the classifying apparatus 1 where the emulsion flows. The use of a classifying apparatus of the present embodiment enables a favorable classification into liquid droplets having a liquid droplet diameter (volume average diameter of liquid droplets) in a range of about 1 to 100 μm, more preferably in a range of about 10 to 50 μm.

That is, a thickness of the intermediate plate 3, i.e. the smallest width or depth (smallest length) of the flow path is set to be smaller than the largest diameter of liquid droplets contained in an emulsion to be classified, and to be a length that the operator desires in the above length range. In other words, at a desired length, set by the operator, within a range that meets the above conditions, most of the liquid droplets having a diameter larger than the set length coalesce with one another to form a continuous phase when passing through the flow path.

In the classifying apparatus 1 according to the present embodiment, a spacing between the upper plate 2 and the lower plate 4 is a flow path through which an emulsion flows. In the cross section of the flow path, a length of a side of the plate where it comes into contact with an emulsion in a direction perpendicular to a flow direction (length of the upper plate 2 or the lower plate 4 in its extended direction in the cross section of the flow path) is preferably 10 or more times as large as the smallest length between the upper plate 2 and the lower plate 4, further preferably 100 or more times as large as the smallest length between the upper plate 2 and the lower plate 4. In other words, when the shape of cross section of the flow path is rectangular, and the depth of the flow path is the smallest length, a direction orthogonal to the depth, i.e. a width (breadth) is more preferably 10 or more times as large as the depth, further preferably 100 or more times. For example, referring to FIG. 3, when arrows represent flow directions of the emulsion, a length (distance) of a breadth (in the lateral direction) in a plane perpendicular to the flow direction is more preferably 10 or more times as large as a length (distance) k of the depth (in the perpendicular direction) d, further preferably 100 or more times.

It is preferable that a side of the plate where it comes into contact with an emulsion preferably has a length (breadth) of ten times or more as large as the smallest length, which tends to bring an excellent classification (demulsification) effect. That is, with the arrangement in which in the cross section of the flow path, the largest width is ten times or more as large as the smallest width in the cross section, liquid droplets contained in the emulsion can deform in the flow path to fit in the smallest width and can spread in a direction of the largest width. This arrangement allows for an easier supply of the emulsion, which realizes to reduce a pressure drop that occurs when the emulsion is supplied to the classifying apparatus 1.

Specifically, as illustrated in FIG. 1, examples of a method for separating the upper plate 2 and the lower plate 4 from each other, i.e. a method for forming the flow path includes: (a) a method of sandwiching the intermediate plate 3 having the hollow that is a flow path of the emulsion between the upper plate 2 and the lower plate 4; (b) a method of forming the hollow (flow path) by grinding an inner surface of at least one of two plates (upper plate 2 and lower plate 4); and (c) a method of coating at least one of the two plates with a resist material, etching a portion of the resist material corresponding to the flow path, hardening this resist material, and bonding the two plates so that the flow path is formed therebetween.

In the classifying apparatus 1 of the present invention, a length of the flow path through which the emulsion flows is not particularly limited as far as the length is the one that provides a sufficient residence time to classify (demulsify) the emulsion, except for restrictions on structure of the apparatus, e.g. structural conditions for a sufficient provision of the smallest length.

The length of the flow path (flow path length) is more preferably a length capable of existing in the flow path at least two droplets contained in the emulsion, further preferably more than the length capable of existing in the flow path at least two droplets contained in the emulsion. The above flow path length realizes more reliable coalescence of liquid droplets contained in the emulsion inside the flow path. Note that, a coalescence mechanism of two liquid droplets will be described later.

Specifically, the flow path length is more preferably in a range from 1 mm to 10 cm, further preferably in a range from 2 mm to 5 cm. The flow path length shorter than 1 mm could cause a difficulty in preparation of the classifying apparatus and an insufficient classification of liquid droplets contained in the emulsion. On the other hand, the flow path length longer than 10 cm could increase a pressure drop that occurs when the emulsion is flown through the flow path, resulting in inefficiency.

Referring to FIG. 3, the following will describe the flow path length of the flow path through which the emulsion flows. The flow path length of the flow path corresponds to a distance in an emulsion flow direction (length “1” in FIG. 3) in an area of the intermediate plate 3 where the hollow is formed. Note that, in FIG. 3, the shortest flow path length of the flow path corresponds to a distance from the supply port 5 to the exit 6, both of which are provided to the upper plate 2.

In the classifying apparatus 1 of the present embodiment, at least a part of the flow path is made of a material having more affinity with liquid droplets contained in the emulsion (droplet affinity material).

The affinity with liquid droplets is a property capable of wetting the liquid droplets contained in the emulsion. On the other hand, non-affinity with liquid droplets is a property of repelling: the liquid droplets contained in the emulsion. For example, when the foregoing emulsion is an oil-in-water (O/W) type emulsion, the droplet affinity material exhibits lipophilicity, whereas the droplet non-affinity material exhibits hydrophilicity. On the other hand, when the foregoing emulsion is a water-in-oil (W/O) type emulsion, the droplet affinity material exhibits hydrophilicity, whereas the droplet non-affinity material exhibits lipophilicity.

Specifically, in the classifying apparatus 1 according to the present embodiment, surfaces of plates (upper plate 2 and lower plate 4) can be hydrophilic or lipophilic (hydrophobic), but at least a part of walls forming the flow path is made of droplet affinity material. Specifically, in order to classify an oil-in-water type emulsion, i.e. in order to flow the oil-in-water type emulsion through the flow path of the classifying apparatus 1, at least one of the upper plate 2 and the lower plate 4 which come into contact with the emulsion preferably has a lipophilic surface. On the other hand, in order to classify a water-in-oil type emulsion, in order to flow the water-in-oil type emulsion through the flow path of the classifying apparatus 1, at least one of the upper plate 2 and the lower plate 4 which come into contact with the emulsion preferably has a hydrophilic surface.

Here, hydrophilicity is a property of having an affinity for water. Material having hydrophilicity (hydrophilic material) represents a material having a dynamic contact angle of water in oil of less than 90 degree. A surface free energy of the hydrophilic material is more preferably 70 mN/m (70 dyne/cm) or more, which tends to exhibit an affinity for water.

Specifically, examples of the hydrophilic material include glass, cellulose, ion exchange resin, poval, and metal. Especially, glass and metal are favorable for the hydrophilic material.

Meanwhile, lipophilicity (hydrophobicity) is a property of having an affinity for organic solvent. Material having lipophilicity (lipophilic material) represents a material having a dynamic contact angle of water in oil of 90 degree or more. More specifically, it is more preferable that the lipophilic material is a material having a surface free energy of 65mN/m (65 dyne/cm) or less. Such a lipophilic material tends to have an affinity for organic solvent. It is further preferable that the lipophilic material is a material having a surface free energy in a range from 1 to 50 mN/m (1 to 50 dyne/cm).

Specifically, examples of the lipophilic material include: fluorine resin such as polytetrafluoroethylene, ethylene-tetrafluoroethylene copolymer, and polyvinylidene fluoride; olefin resin such as polyethylene, polypropylene, ethylene-propylene copolymer, polystyrene, and polyvinyl chloride; and polydimethylsiloxane. Especially, fluorine resin having an excellent chemical resistance is favorable for the lipophilic material.

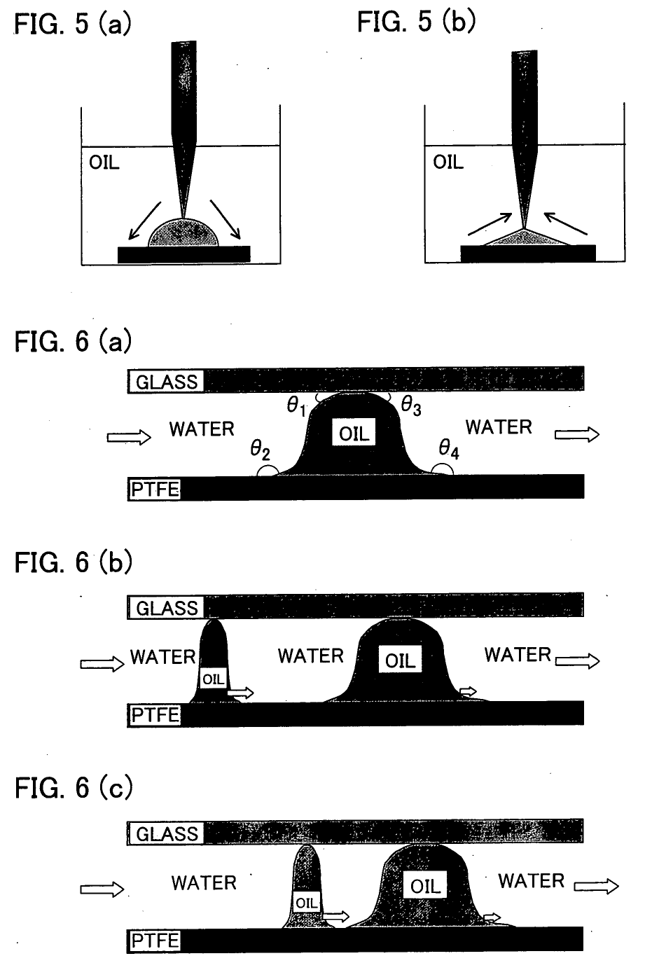

Referring to FIGS. 5(a) and 5(B), the following will describe the dynamic contact angle of water in oil. Note that, “oil” of “water in oil” is the same as a material making up the liquid droplets of the foregoing emulsion (organic solvent).

The dynamic contact angle is measured by means of a contact angle meter. Then, “oil” is used as an organic solvent (organic phase) contained in the emulsion. A static contact angle, a dynamic advance angle, and a dynamic retreat angle of water in the oil (e.g. dodecane or octanol) on the hydrophilic material or lipophilic material (glass or fluorine resin) are measured. More specifically, as illustrated in FIG. 5(a), measurement of the dynamic contact angle is performed as follows: A contact angle (dynamic advance angle) of liquid droplets (water) wetted and spread when they are forced to drop from a needlepoint is measured. Further, as illustrated in FIG. 5(b), a contact angle (dynamic retreat angle) of the liquid droplet drawn up from the needlepoint is measured. It should be noted that the dynamic contact angle of less than 90 degree means that the dynamic advance angle and the dynamic retreat angle are less than 90 degree each. The dynamic contact angle of 90 degree or more means that the dynamic advance angle and the dynamic retreat angle are 90 degree or more each.

Next, the following will describe a coalescence mechanism of liquid droplets when the emulsion is classified by means of a classifying apparatus according to the present embodiment. The following description will be given, as a concrete example, based on a case where the emulsion having oil droplets dispersed in water (dispersion medium) passes through a flow path made of glass and fluorine resin. Note that, glass is a hydrophilic material having a dynamic contact angle of water in oil of less than 90 degree. Further, fluorine resin is a lipophilic material having a dynamic contact angle of water in oil of 90 degree or more.

Condition (i): flow path depth (smallest length)<diameter of an oil droplet (liquid droplet) contained in the emulsion

FIGS. 6(a) through 6(c) are cross sectional views illustrating a classification mechanism of an oil-in-water type emulsion passing through the flow path. As illustrated in FIG. 6(a), when an oil droplet (hereinafter referred to as liquid droplet) contained in the emulsion has a diameter larger than the smallest length (flow path depth) in the cross section of the flow path of the classifying apparatus 1, the liquid droplet deforms as it enters the flow path (microchannel). This increases a surface area of the liquid droplet and causes an unstable interface of the liquid droplet. More specifically, an affinity between the liquid droplet and material forming the flow path causes the liquid droplet to be wetted on the surface of fluorine resin. On the other hand, since water contained in the emulsion has a high affinity for glass (having a dynamic contact angle of 0 degree with respect to glass),.water is wetted and spread on the surface of glass all the time.

That is, as illustrated in FIG. 6(a), water is repelled on the fluorine resin (PTFE) having a 90-degree or more dynamic advance angle (θ2 in FIG. 6(a)) and a 90-degree or more dynamic retreat angle (θ4 in FIG. 6(a)) of water in oil. This causes a slip along a flow of the water. On the other hand, the liquid droplet is wetted and spread on the fluorine resin, but is repelled on the glass surface (θ1 and θ3 in FIG. 6(a)). This difference in wettability between the water and the liquid droplet on the fluorine resin causes difference of a speed in the flow path between the water and the liquid droplet. More specifically, in the flow path, the water passes through the flow path faster than the liquid droplet.

Next, as illustrated in FIG. 6(b), as a small liquid droplet (whose diameter is larger than the depth of the flow path) that is smaller than the liquid droplet staying in the flow path enter the flow path, the small liquid droplet deforms in the flow path in a similar manner as the above liquid droplet. The shape of the small liquid droplet at this moment is the same as the large liquid droplet. Then, the large liquid droplet and the small liquid droplet flow through the flow path. In flowing through the flow path, the small liquid droplet undergoes a smaller force opposite in direction to the flow of the water from wall surfaces than the large liquid droplet. Therefore, the small liquid droplet relatively has a high speed in the flow path than the large liquid droplet. Thus, the small liquid droplet catches up with the large liquid droplet. This will be described below in detail.

For example, an emulsion immediately after being generated by a micromixer has a diameter distribution of liquid droplets. When the emulsion enter the flow path, a force F acting on a liquid droplet contained in the emulsion is expressed by the following equation (1):
F=F1+F2+F3 (1)

where F1 is a force to which the liquid drop is subjected by a flow of water (water flow), F2 is a force to which the liquid droplet is subjected by the surface of fluorine resin in the opposite direction to the flow of water, and F3 is a force to which the liquid droplet is subjected by the surface of glass in the opposite direction to the flow of water.

Here, a volume of arbitrary large liquid droplet is set to VL, and that of a small liquid droplet is set to VS in the emulsion. Forces to which the large liquid droplet and small liquid droplet are subjected by the wall surfaces are expressed by the following equation (2):
F2=−K2A2; F3=−K3A3 (2)

Here, A2 is a contact area between a liquid droplet and the fluorine resin, A3 is a contact area between a liquid droplet and the surface of glass, and K2 and K3 are proportionality constants.

Further, constant areas between a liquid droplet and the wall surfaces are expressed by the following equations (3):
A2∝V; A3∝V (3).

When F2,L is a force to which the large liquid droplet is subjected by the surface of fluorine resin, F3,L is a force to which the large liquid droplet is subjected by the surface of glass, F2,S is a force to which the small liquid droplet (small droplet) is subjected by the surface of fluorine resin, and F3,S is a force to which the small liquid droplet is subjected by the surface of glass, the following equations (4) are formulated:
(F2,L)/(F2,S)=VL/VS;
(F3,L)/(F3,S)=VL/VS (4).

The force F1 to which the liquid droplet is subjected by the flow of water is proportional to a relative velocity with respect to water and a projected area S of the liquid droplet in the flow direction. Here, the projected area S is expressed by the following equation (5):
S∝V^{0.5} (5).

Here, when F1,L is a force to which the large liquid droplet is subjected by the flow of water, and F1,S is a force to which the small liquid droplet is subjected by the flow of water, the following equation (6) is formulated:
(F1,L)/(F1,S)=(VL/VS)^{0.5} (6).

When a force acting on the large liquid droplet is compared with a force acting on the small liquid droplet, from the equations (1), (4), and (6) the following equation (7) is obtained:
(FL/FS)<(VL/VS) (7).

Here, an equation of motion of liquid droplets is expressed by the following equations (8) and (9):
F=m·a (8); and
(mL/mS)=(VL/VS) (9)

where mL is a mass of the large liquid droplet, and mS is a mass of the small liquid droplet.

Now, when aL is an acceleration acting on the large liquid droplet, and aS is an acceleration acting on the small liquid droplet, the following equation (10) is obtained:
aL<aS (10).

Here, both aL and aS are accelerations acting in the opposite direction to the flow of water and are negative values.

A velocity of the liquid droplets immediately after entering the flow path is equal to a water flow velocity (v0) regardless of a size of the liquid droplets. When t is a time elapsed since the liquid droplets enter the flow path, vL is a velocity of the large liquid droplet in the flow path, and vS is a velocity of the small liquid droplet in the flow path, vL and vS are expressed respectively by the following equations (11) and (12):
vL=v0+aL×t (11); and
vS=v030 aS×t (12).

From the equations (8) through (12), vL>vS is obtained. That is, when the liquid droplets enter the flow path, there occurs a difference in velocity between the large liquid droplet and the liquid small droplet due to difference in magnitude of forces to which the liquid droplets is subjected by the wall surfaces. In this manner, as illustrated in FIG. 6(b), the small liquid droplet catches up with the large liquid droplet.

As illustrated in FIG. 6(c), when the small liquid droplet catches up with the large liquid droplet, the two droplets are wetted and spread on the surface of fluorine resin and coalesce with each other into one liquid droplet.

Condition (ii): flow path depth (smallest length) >diameter of a liquid droplet contained in the emulsion

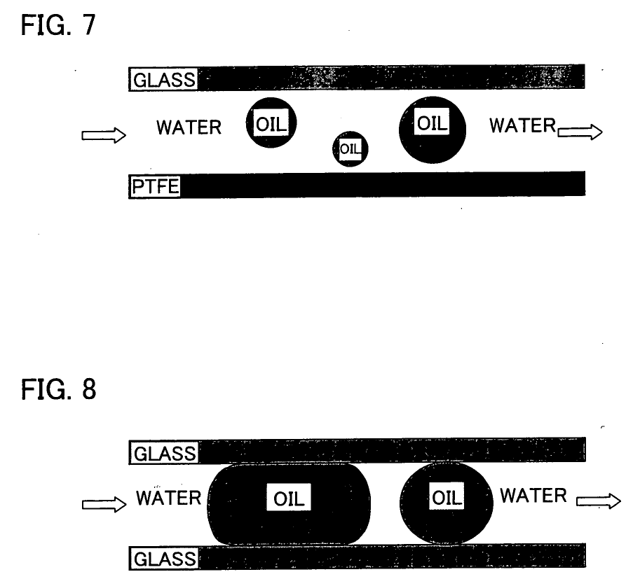

As illustrated in FIG. 7, the liquid droplets are discharged out of the exit of the flow path at the same velocity as water, without being affected by the wall surfaces of the classifying apparatus 1. In other words, when a diameter of a liquid droplet contained in the emulsion is smaller than a flow path depth, the droplet passes without being wetted on the fluorine resin, that is, the droplet is discharged at the same velocity as water because it is not affected by a material forming the flow path. Therefore, in this case, there occurs no droplet coalescence resulting from an influence of the wall surfaces of the flow path. However, there may occur droplet coalescence due to collision between droplets by inertia.

Further, for example, as illustrated in FIG. 8, when an oil-in-water type emulsion is flown through a flow path made of glass only, there occurs no droplet coalescence resulting from an influence of the wall surfaces of the flow path, since the liquid droplets are not wetted on the surface of glass regardless of diameters of the liquid droplets contained in the emulsion. Further, for example, even when two liquid droplets come into contact with each other in the flow path, both of them resist coalescing with each other since there are not wetted on the wall surfaces.

As described above, for coalescence of liquid droplets in the flow path, the following conditions are necessary: (i) a liquid droplet has a diameter larger than a depth of the flow path; and (ii) liquid droplets are wetted on at least a part of material forming the flow path.

It should be noted that the above description has given based on a coalescence mechanism of liquid droplets contained in an oil-in-water type emulsion. Also, in a water-in-oil type emulsion, liquid droplets contained in the emulsion coalesce with each other in a similar manner as described above.

Now, the following will describe a classifying method according to the present embodiment.

To classify (demulsify) an emulsion, the emulsion is supplied from the supply port 5 of the classifying apparatus 1 so that it can be passed through the flow path. In other words, the emulsion is supplied from the supply port 5, flown through the flow path, classified (demulsified) in the flow path, and discharged out of the exit 6.

A residence time of the emulsion in the flow path is set to be a time sufficient for classification (demulsification) of liquid droplets contained in the emulsion. It is more preferable that the residence time is set to be in a range from 0.001 to 10 seconds.

The residence time of the emulsion is preferably not less than 0.001 seconds, which tends to bring an easier manufacture of the apparatus. Also, the residence time of the emulsion is preferably not more than 10 seconds, which tends to reduce a size of the apparatus. The emulsion residence time of less than 0.001 seconds may cause such an insufficient phase-separation of the emulsion that liquid droplets contained in the emulsion are discharged before coalescing with one another.

A flow rate of an emulsion flowing through the flow path (emulsion supply rate) in the classifying apparatus 1 of the present embodiment differs depending upon types of emulsion. Usually, for an emulsion superior in phase-separation, like a water/dodecane emulsion, which exhibits a phase-separation rate of not less than 1 m/min in stationary phase-separation, a flow rate of the emulsion flowing through the flow path is not less than 1 m/min, preferably about 2 to 10 m/min. Such a flow rate enables a sufficient classification. For an emulsion inferior in phase-separation which exhibits a phase-separation rate of less than 1 m/min in stationary phase-separation, a failure of classification may occur if a flow rate of the emulsion flowing through the flow path is not less than 1 m/min even with the use of a classifying apparatus of the present invention. For example, for a stable emulsion that is not separated in a day, like a water/dodecane emulsion containing a surfactant, liquid droplets in the emulsion can coalesce with one another for classification under a condition that a flow rate of the emulsion flowing through the flow path is adjusted to be in a range of about 0.01 m/s to 1 m/s.

That is, the emulsion is supplied to the flow path in such a manner that the emulsion stays in the flow path for the residence time in the above range.

As described above, a classifying apparatus according to the present embodiment is a classifying apparatus which has a flow path having a desired depth or width smaller than the largest diameter in liquid droplets contained in the emulsion, wherein at least a part of walls forming the flow path is made of a material having affinity with the liquid droplets.

With this arrangement, liquid droplets larger in size than a desired depth or width that is smaller than the largest diameter of liquid droplets in the flow path, deform in passing through the flow path, which causes an unstable liquid-liquid interface. Then, when unstable liquid droplets come into contact with each other in a part (state) where the liquid droplets are wetted on the droplet affinity material, they coalesce with each other to be in a stable state.

That is, in passing through the flow path, a liquid droplet larger than the desired depth or width is more likely to coalesce with other liquid droplet. On the other hand, a liquid droplet smaller than the desired depth or width passes through the flow path without undergoing a force from the wall surfaces of the flow path. Therefore, the liquid droplet smaller than the desired depth or width hardly coalesces with other liquid droplet in the flow path.

With this arrangement, under a condition where the smallest length of the flow path is set to be a desired value, a liquid droplet smaller than the smallest distance is directly discharged out of the flow path, without coalescing. On the other hand, a liquid droplet larger than the smallest length coalesces with other liquid droplet to form a larger liquid droplet, and the larger liquid droplet is then discharged. After discharged, the larger liquid droplet coalesces with other larger liquid droplet to form one phase (continuous phase). Further, a liquid droplet smaller than the smallest length keeps in a small liquid droplet state even after having been discharged out of the flow path. Therefore, with the above arrangement, liquid droplets contained in the emulsion are classified so that only liquid droplets having a size smaller than a desired size can be obtained.

Further, at least a part of walls forming the flow path is preferably made of a droplet non-affinity material, which can realize to reduce a pressure drop that occurs during supply of the emulsion.

Especially, it is preferable that two walls forming the flow path are realized by two plate members separated from each other at a distance smaller than the largest diameter of liquid droplets contained in the emulsion, and that the plate members are respectively made of two sheets of plate materials, droplet affinity material and droplet non-affinity material.

Here, when liquid particles (liquid droplets) in the emulsion are water droplets, the droplet affinity material is a hydrophilic material, and the droplet non-affinity material is a lipophilic material. On the other hand, when liquid droplets in the emulsion are oil droplets, the droplet affinity material is a lipophilic material, and the droplet non-affinity material is a hydrophilic material.

It should be noted that the arrangement of the classifying apparatus 1 in which the flow path is formed by three plates: the upper plate 2, the intermediate plate 3 having a hollow; and the lower plate 4, allows the flow path to have an arbitrary depth (width) only with a thickness change of the intermediate plate 3. Therefore, as compared with a conventional classifying apparatus, the classifying apparatus 1 is manufactured at very low cost with an easy maintenance and no microfabriaction requirement.

Further, in the classifying apparatus 1 according to the present embodiment, the emulsion reliably passes through the flow path that is set to have a desired width or depth in its cross section. With this arrangement, a diameter of a liquid droplet discharged out of the flow path can be adjusted to be not more than a given diameter. In addition, as compared with a conventional arrangement, the arrangement of the classifying apparatus 1 can obtain liquid droplets having a narrower droplet diameter distribution range. In other words, as compared with the conventional arrangement, the arrangement of the classifying apparatus 1 can obtain liquid droplets having more uniform diameters.

Further, the classifying apparatus 1 according to the present embodiment changes, into unstable shapes, liquid droplets contained in the emulsion passing through the flow path, which facilitates the liquid droplets to coalesce with each other. That is, when two liquid droplets that exist in the flow path come into contact with each other at portions where they are wetted on the droplet affinity material, they coalesce with each other to be more stable (with a spontaneously acting force that decreases their surface areas). Therefore, as compared with the conventional arrangement, the arrangement of the classifying apparatus 1, even in a condition where a flow rate (supplied amount) of the emulsion supplied to the classifying apparatus 1 is changed to some degree, can perform a favorable classification as far as the flow rate is a flow rate at which liquid droplets (liquid droplets having unstable shapes) can come into contact with each other in the flow path.

Note that, plates (upper plate 2 and lower plate 4) used in the classifying apparatus 1 of the present embodiment have at least hydrophilic and/or hydrophobic surfaces. Specifically, examples of the plates include plates made of hydrophilic material, plates made of hydrophobic material, and plates coated with hydrophilic material and/or hydrophobic material on their surfaces that comes into contact with an emulsion made of a given material. That is, the plates used in the classifying apparatus 1 of the present embodiment exhibit hydrophilicity or lipophilicity only on their surfaces that comes into contact with the emulsion. For example, the plates may be obtained by the following process: a glass substrate or the like is subjected to fluorine-resin processing or the like to obtain a glass substrate having lipophilicity on its surface.

The above plates are separated from each other at least one part thereof at a distance smaller than the largest diameter of liquid droplets contained in the emulsion. For example, the plates may be bent on one part thereof. Note that in this case, the “flow path” is an area that has a width smaller than the largest diameter of liquid droplets.

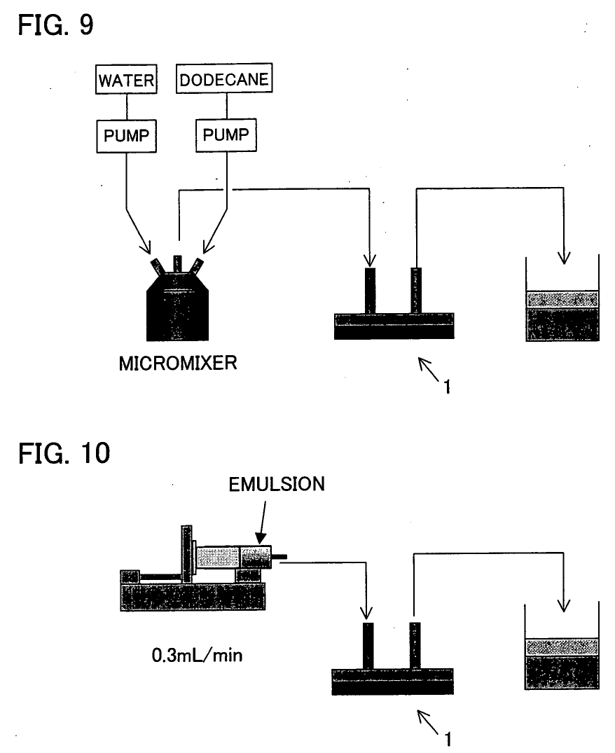

The supply port 5 of the classifying apparatus 1 of the present invention may be connected to a micromixer which can generate an emulsion having tiny liquid droplets. That is, as illustrated in FIG. 9, the supply port 5 of the classifying apparatus 1 of the present invention may be arranged so as to directly supply the emulsion generated by the micromixer to the flow path. Here, the micromixer is an apparatus which can produce submicron liquid droplets. Examples of the micromixer include a micromixer described in “Utilization of Micromixer for Extraction Processes” (Kurt Benz and seven others, Chem. Eng. Technol. 24, 1, 2001, p 11-17). Note that, in the above arrangement, a total amount of aqueous phase (water) and oil phase (organic solvent) supplied to the micromixer determines an amount (rate) of emulsion supplied to the classifying apparatus 1.

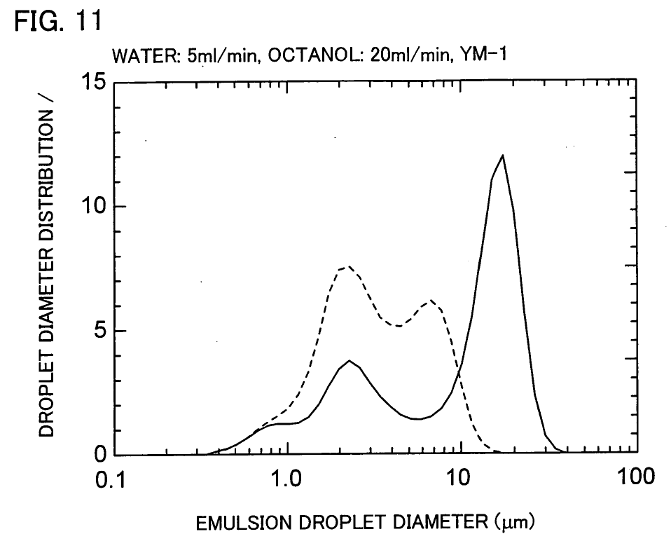

Alternatively, for example, as illustrated in FIG. 10, the emulsion generated by the micromixer may be supplied to the classifying apparatus 1 through another supply apparatus (microsyringe) or the like. Note that, in this arrangement, the amount (rate) of emulsion supplied to the classifying apparatus 1 can be arbitrarily determined regardless of the amount of aqueous phase and oil phase supplied to the micromixer.

Further, in order to continuously and promptly separate a solution discharged out of the exit 6 of the classifying apparatus 1, a liquid-separating apparatus, termed as a settler, may be connected to the exit 6 of the classifying apparatus 1.

As to positions of the supply port 5 and the exit 6, in addition to the positions illustrated in FIGS. 1 and 2, the supply port 5 and the exit 6 may be positioned in a upward direction, downward direction, and lateral direction. Specifically, for example, when the classifying apparatus 1 is composed of three plates: the upper plate 2; the intermediate plate 3; and the lower plate 4, the supply port 5 and/or the exit 6 may be attached to the upper plate 2, the intermediate plate 3, and the lower plate 4.

The number of the supply ports 5 and the exits 5 may be one each. Alternatively, the number of the supply ports 5 and the exits 6 may be more than one each.

In FIG. 2, the flow path (hollow) is rectangular in shape. However, the shape of the flow path through which the emulsion passes may be, for example, a shape having a narrower part on the side where the supply port 5 is provided and a wider part on the side where the exit 6 is provided, and vice versa.

In FIG. 1, the classifying apparatus 1 has one flow path. The number of flow paths may be more than one.

Specifically, examples of the classifying apparatus 1 include: (i) the apparatus as illustrated in FIG. 1; (ii) an apparatus having a plurality of the apparatus of FIG. 1 arranged in all directions, wherein one common supply port 5 and a plurality of exits 6 are provided; (iii) an apparatus having disk-shaped plates (upper plate 2, intermediate plate 3, and lower plate 4), wherein an emulsion is supplied from a center of the disk-shaped plate and discharged from its circumferential part; and (iv) an apparatus having an alternately and repeatedly laminated structure with the upper plate 2, the lower plate 4, and the intermediate plate 3 having a flow path.

Further, in the above description, the flow path of the classifying apparatus 1 is realized by plates (upper plate 2, intermediate plate 3, and lower plate 4). Alternatively, the flow path may be realized by a tube, for example.

With the use of the classifying apparatus 1 according to the present embodiment, even a stable emulsion containing a surfactant (emulsifier), for example, can be classified.

A classifying apparatus according to the present embodiment may have a structure in which an emulsion is flown between at least two plates separated from each other at a distance smaller than the largest diameter of liquid droplets contained in the emulsion.

Further, a classifying apparatus according to the present embodiment may be such that the smallest length between the plates is 1 μm to 100 μm.

Still further, a classifying apparatus according to the present embodiment may be such that in a cross section of an emulsion-flowing structure, a side of the plate where it comes into contact with an emulsion in a direction perpendicular to a flow direction has a length of ten times or more as large as a plate-to-plate distance (smallest length).

Yet further, a classifying apparatus according to the present embodiment may be such that at least one of the plates that comes into contact with an emulsion has a hydrophobic surface.

Further, a classifying apparatus according to the present embodiment may be arranged such that the hydrophobic surface is made of fluorine resin or polyolefine resin.

Still further, a classifying apparatus according to the present embodiment may be arranged such that the emulsion is the one obtained by mixing emulsion materials in a micromixer.

Yet further, a classifying apparatus according to the present embodiment may be arranged such that a settler is connected to the exit.

Further, a classifying apparatus according to the present embodiment may be arranged so as to be a classifying apparatus for classifying an oil-in-water type emulsion, including a flow path having a spacing smaller than the largest diameter in liquid droplets contained in the oil-in-water type emulsion, wherein at least a part of walls forming the flow path is made of a material having a dynamic advance angle and a dynamic retreat angle of water in oil of 90 degree or more each.

Still further, a classifying apparatus according to the present embodiment may be arranged so as to be a classifying apparatus for classifying a water-in-oil type emulsion, including a flow path having a spacing smaller than the largest diameter in liquid droplets contained in the water-in-oil type emulsion, wherein at least a part of walls forming the flow path is made of a material having a dynamic advance angle and a dynamic retreat angle of water in oil of less than 90 degree each.

Further, with the use of a classifying apparatus according to the present embodiment, for example, even an emulsion generated by extraction of a solute of an organic compound to an aqueous phase can be demulsified promptly. Thus, the classifying apparatus according to the present embodiment can favorably perform operations such as washing of solutes unstable toward water and extraction of effluents from aqueous phases.

Yet further, with the use of a classifying apparatus according to the present embodiment, it is possible to produce an emulsion composed of only liquid droplets having a submicroscopic diameter, for example. Then, the emulsion composed of only liquid droplets having a submicroscopic diameter, which has been produced by using this classifying apparatus, is used favorably to manufacture products which are absorbed into the body more quickly as their liquid droplets have a smaller diameter, in the industries such as food industry, agricultural chemical industry, and pharmaceutical industry.

### EXAMPLES

The following will describe the present invention in detail with reference to Examples and Comparative Example. However, the present invention is not limited to them.

(Diameter of Liquid Droplets Contained in an Emulsion)

A diameter of liquid droplets contained in a just-produced emulsion was measured by means of a laser diffraction/scattering particle size distribution analyzer (HORIBA LA-920).

Specifically, after liquid droplets contained in the just-produced emulsion were stabilized in 0.5 wt % of sodium dodecyl sulfate aqueous solution, diameters of the liquid droplets were measured.

It should be noted that an observation result obtained by observing liquid droplets contained in the just-produced emulsion by means of a digital microscope (VH-8000; produced by Keyence Corporation) was about the same as a measurement result obtained by the measurement by means of the laser diffraction/scattering particle size distribution analyzer (HORIBA LA-920).

(Classifying Apparatus)

The following will describe a classifying apparatus used in Examples 1 through 4 given below.

For the classifying apparatus, as illustrated in FIG. 1, used was a classifying apparatus including: the upper plate 2 being provided with the supply port 5 and the exit 6 for an emulsion; the intermediate plate 3 having a hollow; and the lower plate 4, wherein the intermediate plate 3 is sandwiched between the upper plate 2 and the lower plate 4.

Specifically, the intermediate plate 3 is provided with a hollow, as an emulsion flow path, having: (a) a flow path through which an emulsion flows, the flow path having a length of 5 cm (emulsion flow length of 5 cm; indicated with “1” in FIG. 3); and (b) a breadth (length in a direction orthogonal to the smallest length in a cross section of the emulsion flow path; indicated with “k” in FIG. 3) of 1 cm. More specifically, in order to make a distance between the upper plate 2 and the lower plate 4 (smallest length) have a desired value, used was the intermediate plate 3 made of aluminum foil and having a thickness (d) of 12 μm, that is the same as the desired value (produced by Sun Aluminium Ind., Ltd.) (See FIG. 2).

Then, the classifying apparatus 1 was made up by laminating the upper plate 2 (see FIG. 2), the intermediate plate providing the emulsion flow path (see FIG. 3), and the lower plate 4 (see FIG. 4) in order, and then sandwiching the intermediate plate between the upper plate 2 and the lower plate 4 by sealing their side surfaces (see FIG. 1).

It should be noted that plates used as the upper plate 2 and the lower plate 4 are as follows (surface treatment is not especially performed on them):

Glass: glass for Präparat (2 mm in thickness; quartz glass; produced by Eikoh Co., Ltd.)

PE: polyethylene sheet (6 mm in thickness; product name: SUNFRIC (general abrasion resistance grade: UE550); produced by Kyodo Co., Ltd.)

PP: polypropylene sheet (6 mm in thickness; product name: Kobe Polysheet PP; produced by Shin-Kobe. Electric Machinery Co., Ltd.)

PTFE: polytetrafluoroethylene sheet (2 mm in thickness; product name: PTFE sheet; Yodogawa Hu-Tech Co., Ltd.)

### Example 1

For production of an emulsion, water and dodecane were supplied to a micromixer (produced by IMM GmbH; single mixer) at rates of 2.7 ml/min and 0.3 ml/min, respectively. Then, diameters of liquid droplets contained in a just-produced emulsion were measured by means of the laser diffraction/scattering particle size distribution analyzer (HORIBA LA-920).

Next, an outlet of the micromixer was connected to the supply port 5 of the classifying apparatus including the upper plate 2 made of glass and the lower plate 4 made of PE, and the emulsion was supplied to the classifying apparatus at a rate of 3 ml/min. Then, liquids discharged out of the exit 6 of the classifying apparatus were stored in a measuring cylinder (7 mm in diameter). Of generated aqueous phase part and oil phase part, the aqueous phase part was observed. If the aqueous phase part was clouded, failure of demulsification of the emulsion is indicated with x. On the other hand, if the aqueous phase part was clear, no-failure of demulsification of the emulsion is indicated with O. Observation results are shown in Table 1.

### Example 2

Except for the use of a classifying apparatus including the upper plate 2 made of glass and the lower plate 4 made of PP, obtained liquids were observed as in Example 1. Observation results are shown in Table 1.

### Example 3

Except for the use of a classifying apparatus including the upper plate 2 made of glass and the lower plate 4 made of PTFE, obtained liquids were observed as in Example 1. Observation results are shown in Table 1.

### Example 4

Except for the use of a classifying apparatus including the upper plate 2 made of PTFE and the lower plate 4 made of PTFE, obtained liquids were observed as in Example 1. Observation results are shown in Table 1.

TABLE 1

| | Example1 | Example2 | Example3 | Example4 |
|---|---|---|---|---|
| Upper Plate | Glass | Glass | Glass | PTFE |
| Lower Plate | PE | PP | PTFE | PTFE |
| Plate-to-Plate | 12 | 12 | 12 | 12 |
| Distance (μm) | | | | |
| Residence Time (s) | 0.12 | 0.12 | 0.12 | 0.12 |
| Flow Rate (m/s) | 0.42 | 0.42 | 0.42 | 0.42 |
| Classification | ◯ | ◯ | ◯ | ◯ |

### Comparative Example 1

The emulsion (5 ml) used in Example 1 was let stand in a measuring cylinder (7 mm in diameter) for one hour. After that, the emulsion was observed. As a result of the observation, there existed a whitish phase on an interface between the aqueous phase part and the oil phase part.

(Classifying Apparatus)

The following will describe a classifying apparatus used in Examples 5 through 9 given below.

A classifying apparatus including an upper plate made of the foregoing glass and a lower plate made of the foregoing PTFE was used. More specifically, for an intermediate plate, used was a 12 μm-thick aluminum foil having a 10-by-10 mm hollow. In addition, a distance between a supply port and an exit, provided on the upper plate, was set to be 5 mm (emulsion flow length of 5 mm; indicated with “1” in FIG. 3). Then, the classifying apparatus was made up in the same manner as the classifying apparatus used in Example 1.

In a classifying apparatus used in Example 9, a thickness of the aluminum foil (produced by Nilaco Corporation) is 5 μm. In a classifying apparatus used in Example 10, a thickness of the aluminum foil is 12 μm. In a classifying apparatus used in Example 11, a thickness of the aluminum foil is 24 μm. Except for a thickness of the aluminum foil, the classifying apparatuses have the same arrangement as the classifying apparatus used in Example 5.

In classifying apparatuses used in Comparative Examples 2 and 3, the foregoing glass was used for their lower plates. Except for a material of the lower plate, they have the same arrangement as the classifying apparatus used in Example 5.

In classifying apparatuses used in Example 7 and Comparative Examples 2 and 3, a micromixer was directly connected to the supply port of the classifying apparatus. In Examples 8 through 11, an emulsion generated by a micromixer was put in a syringe, and thereafter the emulsion was supplied from the syringe to the classifying apparatus.

(Dynamic Contact Angle)

As to water, on glass and PTFE, in an oil (dodecane or octanol; organic solvent contained in an emulsion to be measured), a static contact angle, a dynamic contact angle, and a dynamic retreat angle (dynamic contact angle) were measured by means of a contact angle meter (produced by Kyowa Interface Science Co., Ltd.; CA-V). Measurement of the dynamic contact angle was performed as follows: As illustrated in FIGS. 5(a) and 5(b), images of (i) a contact angle of a liquid being wetted and spread when the liquid was forced to drop from a needlepoint (dynamic advance angle) and (ii) a contact angle of a liquid drawn up from a needlepoint (dynamic retreat angle) were captured in time series, and then analysis was performed. A result of the analysis is shown in Table 2.

TABLE 2

| | | | | | 1.0 wt % of Sodium | |
|---|---|---|---|---|---|---|
| | | | | | Dodecyl Sulfate | |
| | Dodecane | | Octanol | | Aqueous Solution | |
| Solid | Glass | PTFE | Glass | PTFE | Glass | PTFE |
| θ | 79° | 152° | 49° | 140° | | |
| θ ad | 83° | 160° | 52° | 161° | 10° | 160° |
| θ re | 0° | 160° | 0° | 125° | 0° | 160° |

θ: Static Contact Angle
θ ad: Dynamic Advance Angle
θ re: Dynamic Retreat Angle

### Example 5

For production of an emulsion, water containing 1 wt % of sodium dodecyl sulfate and dodecane were supplied to the micromixer of Example 1 at a rate of 2 ml/min each. Next, for classification, by using a microsyringe pump, a pre-produced emulsion was supplied at a rate of 0.3 ml/min to the classifying apparatus 1 having the upper plate 2 made of glass, the lower plate 4 made of PTFE, and the intermediate plate 3 having laminated four sheets of aluminum foil to make a 48 μm-wide flow path (Type 2). A result of the classification is shown in Tables 3 and 4.

### Example 6

Except for the intermediate plate 3 having laminated six sheets of aluminum foil to make a 72 μm-wide flow path, classification was performed as in Example 5. A result of the classification is shown in Tables 3 and 4.

### Example 7

For production of an emulsion, water and dodecane were supplied to the micromixer used in Example 1 at rates of 2.7 ml/min and 0.3 ml/min, respectively.

Next, an outlet of the micromixer is connected through a silicon tube to the supply port of the classifying apparatus. Then, for classification, the emulsion was supplied at a rate of 3.0 ml/min from the supply port to the classifying apparatus (Type1). A result of the classification is shown in Tables 3 and 4.

A graph of FIG. 11 shows droplet diameter distributions of (a) liquid droplets contained in an emulsion before being classified and (b) liquid droplets contained in a liquid obtained after classification. In FIG. 11, a droplet diameter distribution after classification is shown by a dotted line, and a droplet diameter distribution before classification is shown by a solid line.

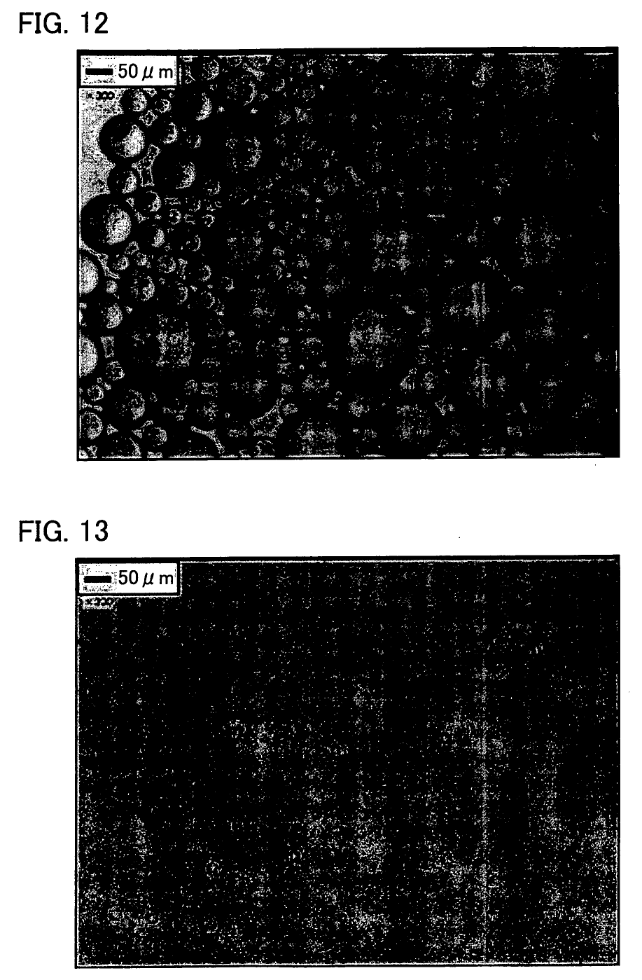

FIG. 12 shows a microscope image of a state of an emulsion before being classified. FIG. 13 shows a microscope image of a state of an emulsion after being classified.

### Example 8

For production of an emulsion, water and octanol were supplied to a micromixer (produced by Yamatake Corporation; YM-1) at rates of 20.0 ml/min and 5.0 ml/min, respectively. Thereafter, the produced emulsion was impounded in a syringe. Then, the emulsion was supplied at a rate of 0.3 ml/min by using a pump. Except for these conditions, classification of an emulsion was performed as in Example 7. A result of classification is shown in Tables 3 and 4.

### Comparative Example 2

Except for the use of a classifying apparatus including the lower plate made of a different material (lower plate: glass, upper plate: glass), classification of an emulsion was performed as in Example 7. A result of classification is shown in Tables 3 and 4.

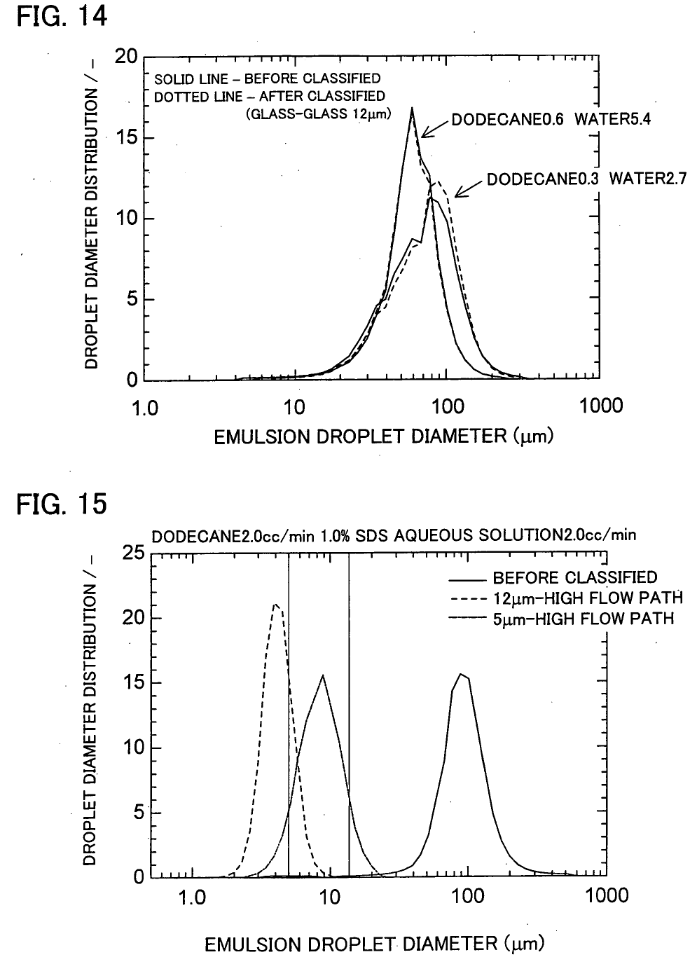

A graph of FIG. 14 shows droplet diameter distributions of (a) liquid droplets contained in an emulsion before being classified and (b) liquid droplets contained in a liquid obtained after classification. In FIG. 14, a droplet diameter distribution after classification is shown by a dotted line, and a droplet diameter distribution before classification is shown by a solid line.

### Comparative Example 3

For production of an emulsion, water and dodecane were supplied to a micromixer (same as the micromixer used in the Example 7) at rates of 5.4 ml/min and 0.6 ml/min, respectively. Thereafter, the produced emulsion was supplied at a rate of 6.0 ml/min to the classifying apparatus. Except for these conditions, classification of an emulsion was performed as in Comparative Example 2. A result of classification is shown in Tables 3 and 4.

A graph of FIG. 14 shows droplet diameter distributions of (a) liquid droplets contained in an emulsion before being classified and (b) liquid droplets contained in a liquid obtained after classification. In FIG. 14, a droplet diameter distribution after classification is shown by a dotted line, and a droplet diameter distribution before classification is shown by a solid line.

### Example 9

For production of an emulsion, 1.0 wt % of sodium dodecyl sulfate aqueous solution and dodecane were supplied to a micromixer (same as the micromixer used in the Example 7) at a rate of 2.0 ml/min each. Thereafter, for classification, the produced emulsion was supplied at a rate of 0.3 ml/min to the classifying apparatus. A result of classification is shown in Tables 3 and 4.

### Example 10

For production of an emulsion, 1.0 wt % of sodium dodecyl sulfate aqueous solution and dodecane were supplied to a micromixer (same as the micromixer used in the Example 7) at a rate of 2.0 ml/min each. Thereafter, for classification, the produced emulsion was supplied at a rate of 0.3 ml/min to the classifying apparatus that is the same as the classifying apparatus used in Example 7. A result of classification is shown in Tables 3 and 4.

Note that, a graph of FIG. 15 shows droplet diameter distributions of (a) liquid droplets contained in an emulsion before being classified and (b) liquid droplets contained in a liquid obtained after the emulsion was flown to the classifying apparatuses respectively having a 5 μm-depth flow path (Example 9) and a 12 μm-depth flow path (Example 10) (after classification).

### Example 11

For production of an emulsion, 1.0 wt% of sodium dodecyl sulfate aqueous solution and dodecane were supplied to a micromixer (same as the micromixer used in the Example 7) at a rate of 2.0 ml/min each. Thereafter, for classification, the produced emulsion was supplied at a rate of 0.3 ml/min to the classifying apparatus (having a 24 μm-depth flow path). A result of classification is shown in Tables 3 and 4.

| | | | | | | Average Droplet | |
|---|---|---|---|---|---|---|---|
| | | | | | | Particle Diameter | |
| | | | | | | of Emulsion | |
| | | | | Flow Rate in | Flow Rate in | Immediately After | Types of |
| | | Continuous | Dispersed | Oil Phase | Aqueous Phase | Produced by Mixer | Supply to |
| | Mixer | Phase | Phase | [ml/min] | [ml/min] | (μm) | Device |
| Example5 | IMM | 1.0 wt % of | Dodecane | 2.0 | 2.0 | 71.8 | Type 2 |
| Example6 | | Sodium | | | | 71.8 | |
| | | Dodecyl Sulfate | | | | | |
| | | Aqueous | | | | | |
| | | Solution | | | | | |
| Example7 | IMM | Water | Dodecane | 0.3 | 2.7 | 66.2 | Type 1 |
| Example8 | YM-1 | Water | Octanol | 5.0 | 20.0 | 11.5 | Type 2 |
| Example9 | IMM | 1.0 wt % of | Dodecane | 2.0 | 2.0 | 71.8 | Type 2 |
| Example10 | | Sodium | | | | | |
| | | Dodecyl Sulfate | | | | | |
| | | Aqueous | | | | | |
| | | Solution | | | | | |
| Comparative | IMM | Water | Dodecane | 0.3 | 2.7 | 66.2 | Type 1 |
| Example2 | | | | | | | |
| Comparative | | | | 0.6 | 5.4 | 55.6 | |
| Example3 | | | | | | | |

| | | | | Average Droplet | | |
|---|---|---|---|---|---|---|
| | | | | Particle Diameter | | |
| | Rate of | | | of Emulsion | | |
| | Supply to | Residence | Flow Path | Which Passed | Material of | Material of |
| | Device | Time | Depth of Device | Through Flow | Upper Surface | Lower Surface |
| | [ml/min] | [sec] | [μm] | Path (μm) | of Device | of Device |
| Example5 | 0.3 | 0.48 | 48 | 47.0 | Glass | PTFE |
| Example6 | | 0.72 | 72 | 59.8 | | |
| Example7 | 3.0 | 0.012 | 12 | Close to Zero | | |
| Example8 | 0.3 | 0.120 | 12 | 2.8 | | |
| Example9 | 0.3 | 0.05 | 5 | 3.9 | | |
| Example10 | 0.3 | 0.120 | 12 | 7.9 | | |
| Comparative | 3.0 | 0.012 | 12 | 67.5 | Glass | Glass |
| Example2 | | | | | | |
| Comparative | 6.0 | 0.006 | | 55.4 | | |
| Example3 | | | | | | |

TABLE 4

| | Before Classified | | | After Classified | |
|---|---|---|---|---|---|
| | | Percentage of | | | Percentage of |
| | | Droplets Having | | | Droplets Having |
| | Average Droplet | Diameter Not | | Average Droplet | Diameter Not |
| | Particle | Less Than Flow | Flow Path | Particle | Less Than Flow |
| | Diameter (μm) | Path Depth | Depth (μm) | Diameter (μm) | Path Depth |
| Example5 | 71.84 | 80.3 | 48 | 47.00 | 37.77 |
| Example6 | 71.84 | 43.1 | 72 | 59.81 | 24.21 |
| Example7 | 66.2 | 99.4 | 12 | Impossible to Measure due to | |
| | | | | Extreme Paucity of Droplets | |
| Example8 | 11.5 | 49.8 | 12 | 2.84 | 0.5 |
| Example9 | 85.9 | 99.5 | 5 | 3.85 | 13.1 |
| Example10 | 85.9 | 91.0 | 12 | 7.89 | 13.7 |
| Comparative | 66.2 | 99.4 | 12 | 67.5 | 99.0 |
| Example2 | | | | | |
| Comparative | 55.6 | 98.7 | 12 | 55.4 | 97.9 |
| Example3 | | | | | |

Out of the above results shown in Tables 3 and 4, Table 5 shows the results of the classifications performed in such a manner that the emulsions produced by supplying 1.0 wt % of sodium dodecyl sulfate aqueous solution and dodecane to a micromixer (same as the micromixer used in the Example 7) at a rate of 2.0 ml/min each were supplied at a rate of 0.3 ml/min respectively to the classifying apparatuses having different flow path depths.

TABLE 5

| | | Before Classified | | After Classified | |
|---|---|---|---|---|---|
| | | | Percentage of | | Percentage of |
| | | | Droplets Having | | Droplets Having |
| | | Average Droplet | Diameter Not | Average Droplet | Diameter Not |
| | Flow Path | Particle | Less Than Flow | Particle | Less Than Flow |
| | Depth (μm) | Diameter (μm) | Path Depth | Diameter (μm) | Path Depth |
| Example9 | 5 | 71.84 | 99.5 | 3.85 | 13.1 |
| Example10 | 12 | 71.84 | 99.0 | 6.53 | 6.0 |
| Example11 | 24 | 71.84 | 98.2 | 15.45 | 2.1 |
| Example5 | 48 | 71.84 | 80.3 | 47.00 | 37.8 |
| Example6 | 72 | 71.84 | 43.1 | 59.81 | 24.2 |

### Example 12

For production of an emulsion, 1.0 wt % of sodium dodecyl sulfate aqueous solution and dodecane were supplied to a micromixer (same as the micromixer used in the Example 7) at a rate of 2.0 ml/min each. Thereafter, for classification of the produced emulsion, the emulsion was supplied at a rate of 1.0 ml/min to the classifying apparatus used in Example 10.

### Example 13

For production of an emulsion, 1.0 wt % of sodium dodecyl sulfate aqueous solution and dodecane were supplied to a micromixer (same as the micromixer used in the Example 7) at a rate of 2.0 ml/min each. Thereafter, for classification of the produced emulsion, the emulsion was supplied at a rate of 0.6 ml/min to the classifying apparatus used in Example

Results of classifications (Examples 10, 12, and 13) performed under the same conditions, except for a supply rate, are shown in Table 6.

TABLE 6

| | | | Before Classified | | After Classified | |
|---|---|---|---|---|---|---|
| | | | | Percentage of | | Percentage of |
| | | | | Droplets Having | | Droplets Having |
| | | | Average Droplet | Diameter Not | Average Droplet | Diameter Not |
| | Flow Rate | Flow Path | Particle | Less Than Flow | Particle | Less Than Flow |
| | (ml/min) | Depth (μm) | Diameter (μm) | Path Depth | Diameter (μm) | Path Depth |
| Example12 | 1.0 | 12 | 71.84 | 99.0 | 31.28 | 51.3 |
| Example13 | 0.6 | 12 | 71.84 | 99.0 | 18.14 | 26.0 |
| Example10 | 0.3 | 12 | 71.84 | 99.0 | 6.53 | 6.0 |

From the above results, it is clear that classification can be performed favorably in an arrangement where the flow path depth is smaller than the largest diameter of liquid droplets contained in the emulsion, and at least a part of walls forming the flow path is made of a droplet affinity material having an affinity with the liquid droplets.

Even when an emulsion containing a surfactant is used, a classifying apparatus according to the present invention can favorably classify its liquid droplets.

As described above, a classifying apparatus according to the present invention has a flow path having a desired depth or width smaller than the largest diameter in liquid droplets contained in an emulsion, wherein at least a part of the flow path is made of a material having affinity with the liquid droplets.

When the emulsion passes through the flow path, the liquid droplets larger than a desired depth or width (hereinafter referred to as the smallest length) smaller than the largest diameter in liquid droplets contained in the emulsion in the flow path, among the liquid droplets contained in the emulsion, deform so as to fit in the smallest length, and the liquid droplets are wetted on a material having an affinity with the liquid droplets (hereinafter it may be referred to as droplet affinity material). Then, when the emulsion is continuously supplied to the flow path, there occurs a difference in relative velocity between a dispersion medium flowing through the flow path and the liquid droplets. This is because the liquid droplets are wetted on the droplet affinity material, and the dispersion medium resists being wetted on the droplet affinity material. Then, if liquid droplets on the upstream of the flow path are smaller in size than liquid droplets on the downstream of the flow path, the liquid droplets on the upstream catch up with the liquid droplets on the downstream. At this moment, the liquid droplets are wetted on the droplet affinity material, and therefore coalesce with other liquid droplets by acting to decrease their surface areas for their stabilities. This causes coalescence of the liquid droplets larger than the smallest length of the flow path by passing through the flow path. On the other hand, liquid droplets smaller than the smallest length of the flow path pass without being wetted on the droplet affinity material and therefore do not coalesce with other liquid droplets. Thus, the smaller liquid droplets keep their shape even after having passed through the flow path.

According to the above arrangement, the liquid droplets larger than the smallest length can be formed to a larger liquid droplet (made coalesced with each other) in such a manner that the liquid droplets contained in the emulsion are caused to pass through the flow path having the smallest length, more specifically, the liquid droplets contained in the emulsion are caused to pass in a wetted state through the flow path. With this, the liquid droplets can coalesce with each other to form a continuous phase, and then separate from the emulsion. Further, the liquid droplets smaller than the smallest length keep as they are.

That is, with the above arrangement, it is possible to reliably flow the liquid droplets contained in the emulsion through the flow path having the smallest length. Thus, it is possible to classify the liquid droplets contained in the emulsion so as to obtain liquid droplets having a desired diameter or smaller.

Further, a classifying apparatus of the present invention is more preferably such that the depth or width is equal to or less than a volume average diameter of the droplets contained in the emulsion.

According to the above arrangement, it is possible to obtain liquid droplets diameter distribution of which is more uniform, by making the depth or width equal to or less than the volume average diameter of the droplets contained in the emulsion.

Still further, a classifying apparatus of the present invention is more preferably such that the flow path is the one having length capable of existing in the flow path at least two droplets contained in the emulsion.

According to the above arrangement, at least two droplets contained in the emulsion can exist in the flow path. Thus, the liquid droplets in the flow path can be more reliably made coalesced with each other.

Yet further, a classifying apparatus of the present invention is more preferably such that a part of walls forming the flow path is further made of a material having more affinity with dispersion medium (hereinafter it may be referred to as droplet non-affinity material), rather than with the droplets contained in the emulsion.

The droplet non-affinity material is a material on which the dispersion medium of the emulsion is more likely to be wetted. With the above arrangement, a part of the flow path made of the droplet non-affinity material, which is more likely to be wet with the dispersion medium of the emulsion, can reduce a pressure drop that occurs when the emulsion is supplied to the flow path.

Further, a classifying apparatus of the present invention is more preferably such that the emulsion is oil-in-water type emulsion, and wherein the droplet affinity material is a material having affinity with oil and having a dynamic contact angle of water in oil of 90 degree or more.

According to the above arrangement, as the droplet affinity material, a lipophilic material having a dynamic contact angle of water in oil of 90 degree or more is used. Therefore, in a case where an oil-in-water type emulsion is used as the emulsion, the liquid droplets contained in the oil-in-water type emulsion flowing in the flow path can be reliably wetted thereon. This can realize more excellent classification of the oil-in-water type emulsion. Note that, the “oil” is the same as a component (organic solvent) of oil droplets (liquid droplets) contained in the foregoing emulsion.

Still further, a classifying apparatus of the present invention is more preferably such that the material having affinity with oil is fluorine resin.

Fluorine resin is superior in chemical resistance. Therefore, according to the above arrangement, with the use of fluorine resin as the lipophilic material, it is possible to favorably classify even an emulsion having a high reactivity with respect to a material making up the flow path, for example.

Yet further, a classifying apparatus of the present invention is more preferably such that the emulsion is water-in-oil type emulsion, and wherein the droplet affinity material is a material having the dynamic contact angle of water in oil of less than 90 degree.

According to the above arrangement, as the droplet affinity material, a lipophilic material having a dynamic contact angle of water in oil of less than 90 degree is used. Therefore, in a case where a water-in-oil type emulsion is used as the emulsion, the liquid droplets contained in the water-in-oil type emulsion flowing in the flow path can be reliably wetted thereon. This can realize more excellent classification of the oil-in-water type emulsion. Note that, the “oil” is the same as a component (organic solvent) of liquids making up the foregoing emulsion.

Further, a classifying apparatus of the present invention is more preferably such that the shape of cross section of the flow path is rectangular, and the smallest length in the cross section is smaller than the largest diameter of the liquid droplets contained in the emulsion and the largest length in the cross section is ten times or more as large as the smallest length in the cross section.

According to the above arrangement, the shape of the cross section of the flow path is rectangular, and the smallest (shortest) length (depth or width) in the cross section is smaller than the largest diameter of the liquid droplets contained in the emulsion. In addition, the largest length in the cross section is ten times or more as large as the smallest length in the cross section. With this arrangement, it is possible to more easily deform liquid droplets contained in the emulsion when the liquid droplets pass through the flow path. That is, the above flow path allows the liquid droplets contained in the emulsion to more easily deform to fit in the smallest length of the flow path, and to escape to a wide space, as compared with a flow path being circular in cross section and having a diameter equal to or smaller than the largest diameter of the liquid droplets, for example. This can realize a smaller pressure drop that occurs when the emulsion is supplied to the flow path. As compared with the flow path being circular in cross section, the above flow path can have a larger cross-sectional area, thereby flowing more emulsion through the flow path. This increases productivity.

Still further, a classifying apparatus of the present invention is more preferably such that the walls forming the flow path contain at least two sheets of plate materials and the two sheets are separated less than the largest diameter of the liquid droplets contained in the emulsion.

According to the above arrangement, a part of walls forming the flow path is realized by plate materials. Thus, it is possible to more easily form the flow path.

Yet further, a classifying apparatus of the present invention is more preferably such that the emulsion is the one obtained by mixing emulsion materials in a micromixer.

The emulsion generated by mixing of the above material by means of a micromixer contains extremely small droplets. Generally, it is believed difficult that extremely small liquid droplets coalesce with each other for their high stability. However, the above arrangement can realize a favorable coalescence even with the use of the emulsion having extremely small liquid droplets, which is generated by a micromixer.

Further, a classifying apparatus of the present invention is more preferably such that the flow path has an exit discharging the emulsion, and a liquid separating apparatus is connected to the exit.

According to the above arrangement, the liquid separating apparatus (settler) is provided at the emulsion exit of the flow path. This enables a continuous and prompt separation of a classified emulsion.

Still further, a classifying apparatus of the present invention is more preferably such that the apparatus has at least two flow paths.

According to the above arrangement, the apparatus has at least two flow paths. This enables more emulsion to be classified at once.

As described above, a method for classifying emulsion of the present invention includes passing emulsion through a flow path in an apparatus for classifying emulsion, wherein the apparatus has a flow path having a desired depth or width smaller than the largest diameter in liquid droplets contained in the emulsion, and wherein at least a part of walls forming the flow path is made of a material having affinity with the liquid droplets.

According to the above arrangement, the liquid droplets larger than the smallest length can be formed to a larger liquid droplet (made coalesced with each other) in such a manner that the liquid droplets contained in the emulsion are caused to pass through the flow path having the smallest length, more specifically, the liquid droplets contained in the emulsion are caused to pass in a wetted state through the flow path. Further, liquid droplets smaller than the smallest length keep as they are.

That is, with the above arrangement, it is possible to reliably flow the liquid droplets contained in the emulsion through the flow path having the smallest length. Therefore, the liquid droplets larger than the smallest length can coalesce with each other to form a continuous phase, and then separate from the emulsion. Thus, it is possible to classify the liquid droplets contained in the emulsion so as to obtain liquid droplets having a desired diameter or smaller.

A method for classifying emulsion of the present invention is more preferably such that residence time of said emulsion in the flow path ranges from 0.001 to 10 seconds.

The above arrangement enables more reliable classification of the liquid droplets contained in the emulsion.

A method for demulsifying emulsion of the present invention includes passing emulsion through a flow path in an apparatus for classifying emulsion and phase-separating the passed liquid, wherein the apparatus has a flow path having a desired depth or width smaller than the largest diameter in liquid droplets contained in the emulsion, and wherein at least a part of walls forming the flow path is made of a material having affinity with the liquid droplets.

According to the above arrangement, the liquid droplets larger than the smallest length can be formed to a larger liquid droplet (made coalesced with each other) in such a manner that the liquid droplets contained in the emulsion are caused to pass through the flow path having the smallest length, more specifically, the liquid droplets contained in the emulsion are caused to pass in a wetted state through the flow path. Thus, it is possible to easily phase-separate the emulsion for demulsification.

Specific embodiments or examples implemented in the description of the best mode for carrying out the invention only show technical features of the present invention and are not intended to limit the scope of the invention. Variations can be effected within the spirit of the present invention and the scope of the following claims.

### INDUSTRIAL APPLICABILITY

A classifying apparatus according to the present invention has favorable applications including obtaining of tiny liquid droplets by classification performed in such a manner that large liquid droplets in an emulsion having liquid particles (liquid droplets) of different particle diameters (droplet diameters) are made coalesced with each other.

1. An apparatus for classifying emulsion which has a flow path having a desired depth or width smaller than the largest diameter in liquid droplets contained in the emulsion,
wherein at least a part of walls forming the flow path is made of a material having affinity with the liquid droplets.

2. The apparatus according to claim 1, wherein the depth or width is equal to or less than a volume average diameter of the droplets contained in the emulsion.

3. The apparatus according to claim 1, wherein the flow path is the one having length capable of existing in the flow path at least two droplets contained in the emulsion.

4. The apparatus according to claim 1, wherein a part of walls forming the flow path is further made of a material having more affinity with dispersion medium.

5. The apparatus according to claim 1, wherein the emulsion is oil-in-water type emulsion, and wherein the material having affinity with the liquid droplets is a material having affinity with oil and having a dynamic contact angle of water in oil of 90 degree or more.

6. The apparatus according to claim 5, wherein the material having affinity with oil is fluorine resin.

7. The apparatus according to claim 1, wherein the emulsion is water-in-oil type emulsion, and wherein the material having affinity with the liquid droplets is a material having the dynamic contact angle of water in oil of less than 90 degree.

8. The apparatus according to claim 1, wherein the shape of cross section of the flow path is rectangular, and wherein the smallest length in the cross section is smaller than the largest diameter of the liquid droplets contained in the emulsion and the largest length in the cross section is ten times or more as large as the smallest length in the cross section.

9. The apparatus according to claim 1, wherein the walls forming the flow path contain at least two sheets of plate materials and the two sheets are separated less than the largest diameter of the liquid droplets contained in the emulsion.

10. The apparatus according to claim 1, wherein the emulsion is the one obtained by mixing emulsion materials in a micromixer.

11. The apparatus according to claim 1, wherein the flow path has an exit discharging the emulsion, and a liquid separating apparatus is connected to the exit.

12. The apparatus according to claim 1, wherein the apparatus has at least two flow paths.

13. A method for classifying emulsion which comprises passing emulsion through a flow path in an apparatus for classifying emulsion, wherein the apparatus has a flow path having a desired depth or width smaller than the largest diameter in liquid droplets contained in the emulsion, and
wherein at least a part of walls forming the flow path is made of a material having affinity with the liquid droplets.

14. The method according to claim 13, wherein residence time of said emulsion in the flow path is from 0.001 to 10 seconds.

15. A method for demulsifying emulsion which comprises passing emulsion through a flow path in an apparatus for classifying emulsion and phase-separating the passed liquid, wherein the apparatus has a flow path having a desired depth or width smaller than the largest diameter in liquid droplets contained in the emulsion, and wherein at least a part of walls forming the flow path is made of a material having affinity with the liquid droplets.
